(19) United States
(12) Patent Application Publication
(10) Pub. No.: US 2015/0140537 A1
(43) Pub. Date: May 21, 2015

(54) BLOOD SIMULANT FOR SIMULATOIN-BASED MEDICAL TRAUMA TRAINING

(71) Applicants: Oleg Grinevich, Holland, OH (US); Igor L. Zheldakov, Perrysburg, OH (US); Puran Kumar De, Cincinnati, OH (US); Alexandre Mejiritski, Bowling Green, OH (US); Douglas C. Neckers, Perrysburg, OH (US)

(72) Inventors: Oleg Grinevich, Holland, OH (US); Igor L. Zheldakov, Perrysburg, OH (US); Puran Kumar De, Cincinnati, OH (US); Alexandre Mejiritski, Bowling Green, OH (US); Douglas C. Neckers, Perrysburg, OH (US)

(73) Assignee: Spectra Group Limited, Inc., Millbury, OH (US)

(21) Appl. No.: 14/546,278

(22) Filed: Nov. 18, 2014

Related U.S. Application Data
(60) Provisional application No. 61/906,049, filed on Nov. 19, 2013.

(51) Int. Cl. G09B 23/28; C09K 3/00

(52) U.S. Cl. CPC G09B 23/28; C09K 3/00
USPC 434/262; 524/590; 106/272; 524/503; 524/556

(57) ABSTRACT

A non-biological simulant liquid that includes about 30 to about 95 parts by weight of a polymer dispersion or a wax emulsion or dispersion, about 5 to about 70 parts by weight of a rheology modifying agent, and a pigment or a pigment combination. The non-biological simulant has a viscosity that is shear-dependent, such that the viscosity is from about 30 cP to about 300 cP at a shear rate from 0 s⁻¹ to about 10 s⁻¹, and such that the viscosity decreases when the shear rate increases. The pigment or pigment combination imbues the non-biological simulant with a color that approximates that of human or animal arterial or venous blood.

### CROSS REFERENCE TO RELATED APPLICATIONS

This application claims the benefit of U.S. Provisional Application No. 61/906,049 filed Nov. 19, 2013, the entirety of which is hereby incorporated by reference.

### GOVERNMENT LICENSE RIGHTS

This invention was made with government support under Contract No. W81XWH-11-C-0073-P00001, awarded by the U. S. Army. The government has certain rights in the invention.

### TECHNICAL FIELD

A non-biological blood simulant of use in simulation-based medical trauma training, for training firefighters, military personnel, and other rescue/emergency medical service personnel, and for use in the entertainment fields, such as in the movie making and personal gaming industries.

### BACKGROUND

Training army personnel for various extreme situations is a crucial component of being prepared for combat missions. It is important that every participant in combat is trained to stop bleeding and conduct hemorrhage control. As of the time of this filing, four out of nine critical training procedures involve the use of animal blood. However, the use of animal blood creates an inherent biological hazard and requires the extensive use of live animals. The use of an artificial blood simulant would be a safer and less expensive route for training.

To be effective as a medical training tool, a blood simulant must be able to realistically reproduce situations that the trainee could encounter in the field. For example, the blood simulant should preferably approximate the viscosity, flow characteristics, and clotting properties to those of actual blood. For enhanced realism, the blood simulant may also mimic the appearance, tactile feel, and odor of actual blood.

### SUMMARY OF THE INVENTION

In one aspect, a non-biological simulant liquid is disclosed. The simulant liquid includes about 30 to about 95 parts by weight of a polymer dispersion or a wax emulsion or dispersion, about 5 to about 70 parts by weight of a rheology modifying agent, and a pigment or a pigment combination. The non-biological simulant has a viscosity that is shear-dependent, such that the viscosity is from about 30 cP to about 300 cP at a shear rate from 0 s⁻¹ to about 10 s⁻¹, and such that the viscosity decreases when the shear rate increases. The pigment or pigment combination imbues the non-biological simulant with a color that approximates that of human or animal arterial or venous blood.

In another aspect, a non-biological simulant liquid includes about 30 to about 95 parts by weight of an alkali resistant acrylic polymer emulsion or a polyethylene wax emulsion, about 5 to about 70 parts by weight of a rheology modifying agent, the rheology modifying agent including a hydrophobic fumed silica dispersion, a water-based pigment combination, the pigment combination including magenta, yellow, and black pigments having a particle size of about 20 nm to about 150 nm, and a matting agent, the matting agent including a coarse-grained precipitated silica. The non-biological simulant has a viscosity that is shear-dependent, such the viscosity is from about 30 cP to about 300 cP at a shear rate from 0 s⁻ⁱto about 10 s⁻¹, and such that the viscosity decreases when the shear rate increases. The non-biological simulant has a color and an odor that approximates the odor of human or animal arterial or venous blood. When the non-biological simulant liquid forms a dried residue, the dried residue has a low gloss appearance that approximates the appearance of dried human or animal arterial or venous blood.

In yet another aspect, a training system is disclosed. The training system includes a water-based non-biological blood simulant capable of forming a solid or semisolid residue representative of clotting blood and a simulant gauze including a clotting agent, the clotting agent including a superabsorbent material. Contact between the simulant gauze and the non-biological blood simulant induces formation of the solid or semisolid residue.

Other aspects of the invention will be readily apparent in view of the descriptions and examples presented herein.

### BRIEF DESCRIPTION OF THE DRAWINGS

FIG. 1 is a graph comparing the rheological profile of bovine blood with the rheological profile of one embodiment of the disclosed non-biological simulant liquid;

FIG. 2 is a graph comparing the absorbance of bovine blood with the absorbance of one embodiment of the disclosed non-biological simulant liquid;

FIG. 3 depicts the cross-section of a simulant gauze for use in accordance with one embodiment of the disclosed training system.

### DETAILED DESCRIPTION

The non-biological simulant liquid (NBSL) disclosed herein is not suitable for use as a biological blood substitute. It simulates blood only with respect to look, feel, smell, flow characteristics, etc., but does not simulate the biological functionality of blood in a living organism.

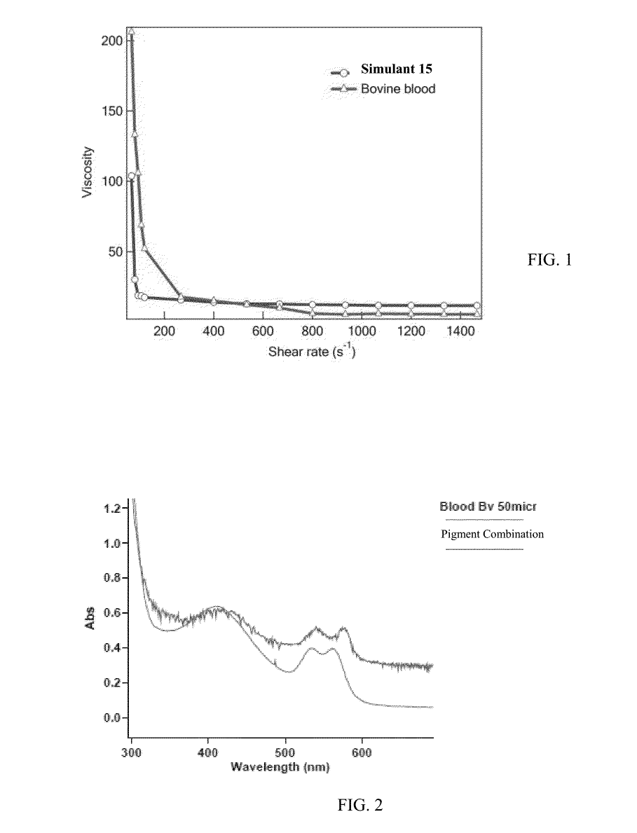

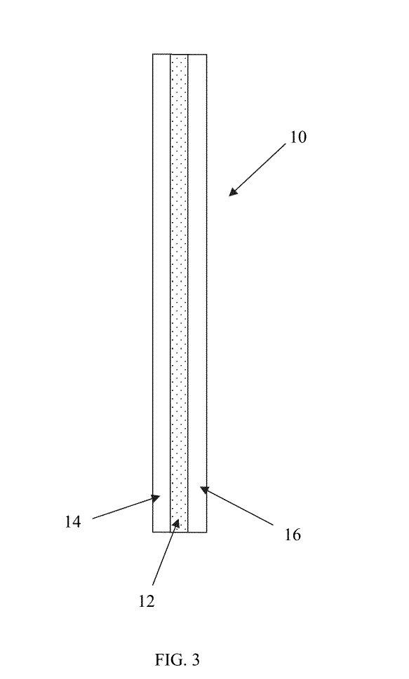

The NBSL mimics the rheological profile of blood (as used herein, the term “blood” refers to human or animal arterial or venous blood), including blood's non-Newtonian properties with respect to static and dynamic viscosity, as seen in FIG. 1, which compares a formulation of the NBSL (Simulant 15 of the table below) with bovine blood in terms of fluid viscosity as a function of shear rate. The NBSL may have a shear-dependent viscosity, which in one embodiment ranges from about 2 cP to about 300 cP, where the NBSL has a viscosity of up to about 300 cP when measured at low shear rates (from 0 s⁻¹ to about 10 s⁻¹) and a viscosity from about 2 cP to about 30 cP, and in one embodiment from about 2 cP to about 20 cP, when measured at higher shear rates. The NBSL also mimics the appearance of blood, as seen in FIG. 2, which compares the UV-visible spectra of a water-soluble pigment combination suitable for use in the NBSL and bovine blood. Because the NBSL is water-based, the spectrum of an NBSL incorporating the pigment combination would be similar.

To achieve these properties, the NBSL is formed of a combination of a polymer dispersion or a wax emulsion/dispersion, a rheology modifying agent; and a pigment or a pigment combination. As used herein, the term “wax emulsion/dispersion” should be understood to include both liquid-in-liquid mixtures and solid-in-liquid mixtures. The NBSL may further include a matting agent to give the NBSL an appearance, when dried, that mimics the appearance of dried blood. The NBSL may further include an odor agent to give the NBSL an odor that approximates the odor of human or animal arterial or venous blood. The NBSL may be paired with a simulant gauze incorporating an absorbent material, and in one embodiment a superabsorbent material, such that together, the NBSL and the simulant gauze can be used as a training system to simulate an emergency first aid situation involving bodily injury. Contact between the simulant gauze and the NBSL causes the NBSL to form a solid or semisolid residue, which may have an appearance and other characteristics similar to that of dried, clotted blood.

The polymer dispersion or the wax emulsion/dispersion component of the NBSL is a water-based emulsion or dispersion, which is selected so as to provide mechanical strength to the NBSL when “clotting” to form a semi-solid/solid mass when the water is removed (for example, if the NBSL interacts with a superabsorbent material) that has a consistency approximate to that of dried blood. The polymer/wax element of the polymer dispersion or wax emulsion/dispersion component may form micelles when the component is in liquid form, and these micelles may serve as a binder when the NBSL is dried to a residue. The polymer dispersion or the wax emulsion/dispersion forms about 30 to about 95 parts-by-weight of the NBSL. In one embodiment, the polymer dispersion or the wax emulsion/dispersion is about 40 to about 60 parts of the NBSL.

If the polymer dispersion or the wax emulsion/dispersion component is a polymer dispersion, the polymer dispersion may be a polyurethane dispersion, a urethane acrylic dispersion, an acrylic dispersion, a polyvinyl dispersion, or a combination thereof. Suitable commercially-available polyurethane dispersions include BERMODOL® PUR 2130, BAYHYDROL® 2342, BAYBOND® XP 2469, and IMPRANIL® DLP. Suitable acrylated polyurethane dispersions include UCECOAT® 7689 and BAYHYDROL® 2317. Suitable acrylic dispersions include BAYHDYROL® 2546, JONCRYL® 537, JONCRYL® HRC 1645, and JONCRYL® 8383. Suitable polyvinyl dispersions include RESYN® 1025, RESYN® 1072, and DUR-O-SET® C 310.

If the polymer dispersion or the wax emulsion/dispersion component is a wax emulsion/dispersion, suitable wax emulsion/dispersions include MICHEM® Emulsion 77030, MICHEM® Emulsion 61335, MICHEM® Emulsion 24930, JONWAX® 26, and JONWAX® 28.

The combination of the polymer dispersion or the wax emulsion/dispersion component and the rheology modifying agent provides the NBSL with a rheological profile that approximates the non-Newtonian behavior of blood, as shown in FIG. 1. The term “approximates,” when used herein to compare a property of the NBSL with a property of blood, should be understood to mean that the NBSL may exhibit that property in either a similar or identical fashion. The rheology modifying agent forms from about 5 to about 70 parts by weight of the NBSL, and in one embodiment, from about 40 to about 60 parts. When properly balanced with the polymer dispersion or the wax emulsion/dispersion component, the NBSL will flow when under pressure (for example, through simulated blood vessel tubes of a mannequin), yet the NBSL will tend to thicken when stationary in droplet form. Formulations weighted more heavily toward the polymer dispersion or wax emulsion/dispersion component tend to coagulate more quickly, which may be beneficial in a training environment to enhance realism.

The rheology modifying agent may be a water-based silica dispersion, an acrylic copolymer dispersion, a cellulose-based product, a clay-based product, or any material known in the art as useful for the manipulation of the rheological profile of liquid. In one embodiment, the rheology modifying agent is a hydrophobic fumed silica dispersion provided at 35-70 parts, for example AERODISP® WR 8520 (which can be equivalently formulated from 20% AEROSIL® R972 in water). In addition to the rheological impact, hydrophobic fumed silica dispersions provide additional anti-settling and stability enhancement benefits to the NBSL. In one instance, NBSL samples incorporating AERODISP® WR 8520 were stored for four to six months, and no phase separation was observed. Other suitable dispersion/emulsion-type rheology modifying agents include AEROSIL® R200, AERODISP® W7520, VISCOATEX® 730, and RHEOTECH^{TM} 4800. Other suitable rheology modifying agents include cellulose-based BERMOCOLL® EHM 200, BERMOCOLL® EHM 300, and BERMOCOLL® EBS 411 FQ, and clay-based OPTIGEL® WX, LAPONITE® RD, and LAPONITE® RDS. Cellulose and clay-based rheology modifying agents should be used in smaller percentages as compared to dispersion/emulsion-type agents, for example at or below about 10 parts.

Two attributes to consider in the selection of an appropriate pigment include the quality of the visual appearance as compared to blood (in both liquid and dried forms) and the ability of the pigment to remain in suspension and avoid settling despite long-term storage. The pigments of the NBSL have a particle size of about 20 nm to about 150 nm, which allows them to remain in suspension and resist settling for extended periods of time due to their small size. Red, magenta, yellow, and/or black pigments can be used in combination to approximate the visual appearance of blood. In one embodiment, the NBSL includes from about 0.1 to about 5 parts by weight of a magenta pigment, from about 0.1 to about 5 parts by weight of a yellow pigment, and from 0 to about 0.5 parts by weight of a black pigment (or more preferably from about 0 to about 0.3 parts). The inclusion or exclusion of black pigment is dependent upon whether the NBSL is designed to simulate arterial or venous blood, where black pigment is included only for venous-type NBSLs. Only a small amount of black pigment should be used as compared to pigments of the other colors to both maintain the realism of the appearance of the NBSL in liquid form and to ensure that the NBSL dries as a dark, flaky solid, where the darkness varies depending on the thickness of the NBSL such that the dried NBSL is darker at thicker points. In one embodiment, the NBSL includes about 0.75 parts magenta pigment, about 0.90 parts yellow pigment, and (if venous) about 0.015 parts black pigment to emulate bovine blood.

Water-based pigments of the type designed for use with ink jet printers are suitable for incorporation into the NBSL, such as those produced by Clariant International, Ltd., under their HOSTAJET® product line. Alternatively, other pigment dispersions or coloring agents may be used, such as those designed for paint and general use applications, but they may be less effective in terms of color retention and settlement avoidance.

The matting agent is used to modify the opacity of the NBSL and enhance the realism of the appearance of the NBSL by reducing the glossiness of the NBSL. The matting agent may be a silica, wax, micronized polymer, micronized high density polyolefin, micronized polypropylene, or other material or combination of materials which, upon inclusion in a liquid composition, reduces the glossiness of the composition in dried form. Examples of several suitable matting agents are AQUAMAT® 208, AQUAMAT® 272, CERAFLUOR® 1000, CERAFLUOR® 920, CRAVYLLAC® WN-1875, ACEMATT® TS 100, ACEMATT® 3300, ACEMATT® HK 450, AQUAMATTE® 31, PROPYLMATTE® 31, and PROPYLMATTE® 450. Most matting agents significantly affect the glossiness of the NBSL in dried form, but either do not or otherwise only minimally impact the color/appearance of the NBSL aside from the gloss level.

To emulate the appearance of dried blood, sufficient matting agent should be added to achieve a gloss at or below about 10 GU at a 60° angle. In one embodiment, the NBSL includes from about 0.25 to about 1.25 parts of the matting agent. It was found that the addition of more than 1% matting agent does not significantly affect the gloss level of the resultant NBSL, but that the addition of significant amounts of matting agent (for example 4% or 8%) may, for some matting agents, affect the viscosity and/or color of the resultant NBSL.

Blood has a metallic odor, and providing the NBSL with an odor agent to emulate the smell of blood enhances the realism of training exercises that use the NBSL. In one embodiment, the odor agent is vinyl pentyl ketone (VPK) (IUPAC Name: 1-octene-3-one; CAS Number 4312-99-6), which has an odor that approximates the metallic odor of blood. Notably, VPK is an irritant, so its inclusion may raise safety concerns both in the production process and the ultimate use of the NBSL. The amount of odor agent required is dependent upon the inherent odor of the NBSL absent the odor agent. In an embodiment where the NBSL is otherwise substantially odorless, it is sufficient for the VPK to form from about 0.0002% to about 0.1% of the NBSL. In one embodiment, the NBSL includes about 0.02% VPK.

Various formulations of the NBSL were prepared in accordance with the principles outlined above, and combinations were evaluated for a variety of characteristics as compared to blood, including rheological profile, color and appearance in liquid form, color and appearance in dried (solid/semisolid) form, solid strength after drying, and smell. Several formulations of the NBSL in accordance with the properties described above are illustrated in the table below:

| Component | Simulant 1 | Simulant 2 | Simulant 3 | Simulant 4 | Simulant 5 | Simulant 6 | Simulant 7 | Simulant 8 | Simulant 9 |
|---|---|---|---|---|---|---|---|---|---|
| AERODISP WR | 50 | 50 | 50 | 50 | 50 | 50 | 50 | 50 | 50 |
| 8520 | | | | | | | | | |
| Bermodoll PUR | 7.5 | | | | | | | | |
| 2130 | | | | | | | | | |
| UCECOAT-7689 | | 50 | | | | | | | |
| Bayhydrol UV 2317 | | | 50 | | | | | | |
| Bayhydrol 2342 | | | | 50 | | | | | |
| BH2546-CL7590 | | | | | 50 | | | | |
| BayBond XP 2569 | | | | | | 50 | | | |
| Impranil DLP | | | | | | | 50 | | |
| Joncryl Wax 26 | | | | | | | | 50 | |
| Resyn 1025 | | | | | | | | | 50 |
| Hostajet Magenta | 0.75 | 0.75 | 0.75 | 0.75 | 0.75 | 0.75 | 0.75 | 0.75 | 0.75 |
| E-PT VP 2690 | | | | | | | | | |
| Hostajet Yellow | 0.90 | 0.90 | 0.90 | 0.90 | 0.90 | 0.90 | 0.90 | 0.90 | 0.90 |
| 4G-PT VP 2669 | | | | | | | | | |
| Hostajet Black | | | | | | | | | |
| O-PT | | | | | | | | | |
| Water | 50 | | | | | | | | |
| Property | | | | | | | | | |
| Color | Good | Good | Very good | Good | Fair | Poor | Very poor | Very good | Very poor |
| Fluidity | Good | Good | Very good | Good | Low | Fair | Fair | Good | Low |
| Appearance on | Good | Good | Very good | Good | Fair | Poor color | Fair | Very good | Poor color |
| gauze | | | | | | | | | |
| Stability | >2 months | >2 months | Gelling, 5 d. | >2 months | >2 months | ~1.5 months | >2 months | >2 months | ~1.5 months |
| Dried sample | Pink and | Red and not | Red and not | Red and not | Red and not | Red and not | Pink and | Red but | Red and |
| | powdery | powdery | powdery | powdery | powdery | powdery | not powdery | powdery | plastic-like |
| Clotting/coagulation | 30 min, | 15 min, | 15 min, | 15 min, | 15 min, | 15 min, | 15 min, | 15 min, | 15 min, |
| (static regime) | Good | Very good | Good | Very good | Fair | Bad | Too viscous | Good | Too viscous |
| Washing | Good | Good | Staining | Very good | Staining | Staining | Staining | Good | Fair |
| Viscosity range (cP) | 350-30 | 200-70 | 80-50 | 100-40 | 1600-100 | 50-35 | 300-60 | 25-15 | 400-150 |
| at shear rates | | | | | | | | | |
| between 10-1400 | | | | | | | | | |
| S⁻¹ | | | | | | | | | |
| | Simulant | Simulant | Simulant | Simulant | Simulant | Simulant | Simulant | Simulant | Simulant |
| Component | 10 | 11 | 12 | 13 | 14 | 15 | 16 | 17 | 18 |
| AERODISP WR | 50 | 50 | 50 | 50 | 50 | 50 | 50 | 50 | 50 |
| 8520 | | | | | | | | | |
| Resyn 1072 | 50 | | | | | | | | |
| Dur-O-Set C 310 | | 50 | | | | | | | |
| Joncryl 537 | | | 50 | | | | | | |
| Joncryl Wax 28 | | | | 50 | | | | | |
| Michelman 24930 | 7.5 | | | | 50 | | | | |
| Michelman 61335 | | | | | | 50 | | | |
| Michelman 77030 | | | | | | | 50 | | |
| Joncryl 90 | | | | | | | | 50 | |
| Joncryl 538 | | | | | | | | | 50 |
| Hostajet Magenta | 0.75 | 0.75 | 0.75 | 0.75 | 0.75 | 0.75 | 0.75 | 0.75 | 0.75 |
| E-PT VP 2690 | | | | | | | | | |
| Hostajet Yellow | 0.90 | 0.90 | 0.90 | 0.90 | 0.90 | 0.90 | 0.90 | 0.90 | 0.90 |
| 4G-PT VP 2669 | | | | | | | | | |
| Hostajet Black | | | 0.015 | 0.015 | 0.015 | 0.015 | 0.015 | 0.015 | 0.015 |
| O-PT | | | | | | | | | |
| ACEMATT HK-450 | | | 0.75 | 0.75 | 0.75 | 0.75 | 0.75 | 0.75 | 0.75 |
| Property | | | | | | | | | |
| Color | Poor | Very poor | Good | Good | Good | Good | Good | Good | Good |
| Fluidity | Low | Very low | Good | Good | Good | Good | Good | Good | Good |
| Appearance on | Poor color | Poor color | Good | Good | Good | Good | Good | Good | Good |
| gauze | | | | | | | | | |
| Stability | ~1.5 months | ~1.5 months | >2 months | >2 months | ~1.5 months | >2 months | >2 months | N/A | N/A |
| Dried sample | Pink and | Pink but not | Red and | Red and | Red and | Red and | Red and | Red and | Red/weak |
| | plastic-like | powdery | solid plastic | flaky | flaky | flaky | solid plastic | crushable | plastic, |
| | | | | | | | | into powder | flaky |
| Clotting | 15 min, | 15 min, | 5 min, | 15 min, | 20 min, | 20 min, | 20 min, | 20 min, | 20 min/ |
| | Too viscous | Too viscous | Very good | Good | Good | Good | Good | Good | good |
| Washing | Fair | Staining | Good | Good | Good | Good | Good | Good | Good |
| Viscosity range (cP) | 300-100 | 800-200 | 60-28 | 35-32 | 95-17 | 105-15 | 270-40 | 90-50 | 180-46 |
| at shear rates | | | | | | | | | |
| between 10-1400 | | | | | | | | | |
| S⁻¹ | | | | | | | | | |
| | Simulant | Simulant | Simulant | Simulant | Simulant | Simulant | Simulant | Simulant | Simulant |
| Component | 19 | 20 | 21 | 22 | 23 | 24 | 25 | 26 | 27 |
| AERODISP WR | 50 | 50 | 50 | 50 | 50 | 50 | 50 | 50 | 50 |
| 8520 | | | | | | | | | |
| Joncryl Wax 28 | 50 | 50 | 50 | | | | | | |
| Joncryl 8383 | | | | 50 | | | | | |
| Joncryl 585 | | | | | 50 | | | | |
| Joncryl 660 | | | | | | 50 | | | |
| Joncryl 1536 | | | | | | | 50 | | |
| Joncryl 1620 | | | | | | | | 50 | |
| Joncryl 2156 | | | | | | | | | 50 |
| Hostajet Magenta | 0.75 | 0.75 | 0.75 | 0.75 | 0.75 | 0.75 | 0.75 | 0.75 | 0.75 |
| E-PT VP 2690 | | | | | | | | | |
| Hostajet Yellow | 0.90 | 0.90 | 0.90 | 0.90 | 0.90 | 0.90 | 0.90 | 0.90 | 0.90 |
| 4G-PT VP 2669 | | | | | | | | | |
| Hostajet Black | 0.01 | 0.015 | 0.03 | 0.015 | 0.015 | 0.015 | 0.015 | 0.015 | 0.015 |
| O-PT | | | | | | | | | |
| ACEMATT HK-450 | 0.75 | 0.75 | 0.75 | 0.75 | 0.75 | 0.75 | 0.75 | 0.75 | 0.75 |
| Vinylpentyl ketone | 0.01 | 0.01 | 0.01 | | | | | | |
| Property | | | | | | | | | |
| Color | Good | Good | Fair | Good | Good | Good | Good | Good | Poor |
| Fluidity | Good | Good | Good | Very low | Very low | Low | Low | Low | Fair |
| Appearance on | Good | Good | Good | Good | Poor color | Fair | Good | Fair | Fair |
| gauze | | | | | | | | | |
| Stability | >2 months | >2 months | >2 months | N/A | Unstable | 1-2 days | Gelling in | 3 weeks | N/A |
| | | | | | | | 1-2 days | | |
| Dried sample | Red and | Red and | Red and | Red and | Red and | Red and | Red and | Pinkish and | Pink and |
| | flaky | flaky | flaky | solid plastic | weak plastic | solid plastic | weak plastic | weak plastic | strong |
| | | | | | | | | | plastic |
| Clotting | 15 min, | 15 min, | 15 min, | N/A | N/A | N/A | 15 min, | N/A | N/A |
| | Good | Good | Good | | | | Good | | |
| Washing | Good | Good | Good | Staining | Good | Staining | Good | Fair | Good |
| Viscosity range (cP) | 35-32 | 35-32 | 35-32 | 900-200 | 1450-80 | N/A | 520-110 | 820-120 | 660-80 |
| at shear rates | | | | | | | | | |
| between 10-1400 | | | | | | | | | |
| S⁻¹ | | | | | | | | | |

Referring now to FIG. 3, a training system incorporating the NBSL will be described. The training system includes two basic components: the NBSL as described above and a simulant gauze 10 (hereinafter referred to as “gauze”) that incorporates an absorbent material, and in one embodiment a superabsorbent material. When the gauze 10 interacts with the NBSL, the superabsorbent material in the gauze draws moisture out of the NBSL, serving as a “clotting” agent, and the NBSL coagulates into a solid or semi-solid mass. Thus, the interaction of the gauze with the NBSL simulates the formation of a blood clot. It was found that using superabsorbent materials as the clotting agent results in gradual clot formation of the NBSL that approximates the clotting characteristics of real blood. Through careful selection and dosing of the amount of superabsorbent material in the gauze 10, the speed of liquid removal from the NBSL can be carefully controlled to manipulate the speed of solidification and coagulation of the NBSL into a solid/semi-solid state. In contrast, liquid-based clotting agents tend to cause instantaneous coagulation, which provides a less realistic training experience.

The superabsorbent material may take any of a variety of forms, including a superabsorbent polymer (SAP), a superabsorbent fiber (SAF), a polyacrylic acid, or a combination thereof.

In one embodiment, the gauze 10 is a multi-layer laminate (see FIG. 3, depicting a 3-layer laminate), where the superabsorbent material is disposed in a middle layer 12. The outer layers 14, 16 may be fabric, paper (such as air-laid paper), rayon or a rayon blend, polypropylene, polyester nonwovens, or any liquid-permeable material that is less hydrophilic than the superabsorbent material of the middle layer 12. One or both of the outer layers 14, 16 may further include a SAP and/or SAF therein, for example as a component of an airlaid composite. The laminate may be sized and shaped to conform with that of conventional gauze, for example as a strip or roll. In one embodiment, the laminate may be formed into a strip that is about 3 inches by about 30 inches. In embodiments incorporating an SAP-based middle layer 12, it may be preferable to use a material for the outer layers that is relatively stable when wet to maintain the integrity of the laminate as a whole during use. This is less of a concern in SAF-based embodiments because the SAF remains largely stable and intact even after absorbing liquid.

While the disclosed training system is contemplated for use without any further specialized training equipment, it is contemplated that the training system may also be used in conjunction with other training devices, such as a mannequin equipped with SkedCo's FIELD EXPEDIENT BLEEDING SIMULATION SYSTEM™ (FEBSS), to more realistically simulate actual emergency scenarios. For example, to simulate various wounds that may be encountered in a battlefield, the NBSL can be pumped through artificial blood vessels of an FEBSS to a simulated gunshot wound on a mannequin, where the trainee's goal is to treat the wound using the gauze. The FEBSS/other training aid may be capable of simulating both arterial bleeding (pulsating output) and venous bleeding (constant output) at various flow rates.

For embodiments of the training system intended for use in conjunction with an FEBSS, materials for the NBSL and gauze should be selected to avoid clogging the hoses and openings of the FEBSS. For example, it was found that for embodiments incorporating an SAF-based gauze, a load of SAF of about 10 to about 450 gsm is functional, and a load of about 40 to about 350 gsm is optimal to establish an effective, realistic clot. However, a load of about 90 to 150 gsm, or about 110 gsm, may be more practical when taking into consideration the impact on the FEBSS equipment is being used, because higher loads are more likely to either clog the tubing, result in the release of some of the SAF into the tubing and/or simulated wound, or otherwise make the equipment difficult to clean. A three inch by thirty inch piece of gauze incorporating a 110 gsm load of SAF was found to be able to effectively stop the flow of several tested formulations of the NBSL out of a simulated gunshot wound for over 20 minutes, under both steady and pulsating flow conditions, with only negligible amounts of SAF release into the simulated wound and FEBSS supply lines of the FEBSS, and without clogging the FEBSS supply lines.

What is claimed is:

1. A non-biological simulant liquid comprising:
about 30 to about 95 parts by weight of a polymer dispersion or a wax emulsion or dispersion;
about 5 to about 70 parts by weight of a rheology modifying agent; and
a pigment or a pigment combination;
wherein the non-biological simulant has a viscosity that is shear-dependent, wherein the viscosity is from about 30 cP to about 300 cP at a shear rate from 0 s⁻¹ to about 10 s⁻¹, and wherein the viscosity decreases when the shear rate increases;
wherein the pigment or pigment combination imbues the non-biological simulant with a color that approximates that of human or animal arterial or venous blood.

2. The non-biological simulant liquid of claim 1, wherein the pigment or the pigment combination comprises at least one of a red, magenta, yellow, or a black pigment, or a combination thereof.

3. The non-biological simulant liquid of claim 2, wherein the pigment combination comprises from about 0.1 to about 5 parts by weight of the magenta pigment, from about 0.1 to about 5 parts by weight of the yellow pigment, and from 0 to about 0.5 parts by weight of the black pigment.

4. The non-biological simulant liquid of claim 1, wherein the pigment or the pigment combination is water-based.

5. The non-biological simulant liquid of claim 1, wherein the pigment or pigment combination has a particle size of about 20 nm to about 150 nm.

6. The non-biological simulant liquid of claim 1, wherein the wax emulsion or dispersion comprises a polyethylene wax emulsion.

7. The non-biological simulant liquid of claim 1, wherein the polymer dispersion is a polyurethane dispersion, an acrylic dispersion, a urethane acrylic dispersion, or a polyvinyl dispersion.

8. The non-biological simulant liquid of claim 7, wherein the polymer dispersion comprises an alkali resistant acrylic polymer emulsion.

9. The non-biological simulant liquid of claim 1, wherein the rheology modifying agent comprises a silica dispersion.

10. The non-biological simulant liquid of claim 9, wherein the silica dispersion comprises a hydrophobic fumed silica dispersion.

11. The non-biological simulant liquid of claim 1, further comprising a matting agent to modify the opacity of the non-biological simulant liquid, wherein when the non-biological simulant liquid forms a dried residue, the dried residue has a low gloss appearance that approximates the appearance of dried human or animal arterial or venous blood.

12. The non-biological simulant liquid of claim 11, wherein the simulant liquid comprises about 0.25 to about 1.25 parts by weight of the matting agent.

13. The non-biological simulant liquid of claim 11, wherein the matting agent comprises a silica, a wax, a micronized polymer, a micronized high density polyolefin, a micronized polypropylene, or a combination thereof.

14. The non-biological simulant liquid of claim 13, wherein the matting agent comprises a coarse-grained precipitated silica.

15. The non-biological simulant liquid of claim 1, further comprising an odor agent, the odor agent providing the simulant liquid with a metallic odor that approximates the odor of human or animal arterial or venous blood.

16. The non-biological simulant liquid of claim 15, wherein the odor agent comprises vinyl pentyl ketone.

17. A non-biological simulant liquid comprising:
about 30 to about 95 parts by weight of an alkali resistant acrylic polymer emulsion or a polyethylene wax emulsion;
about 5 to about 70 parts by weight of a rheology modifying agent, the rheology modifying agent comprising a hydrophobic fumed silica dispersion;
a water-based pigment combination, the pigment combination comprising magenta, yellow, and black pigments having a particle size of about 20 nm to about 150 nm; and
a matting agent, the matting agent comprising a coarse-grained precipitated silica;
wherein the non-biological simulant has a viscosity that is shear-dependent, wherein the viscosity is from about 30 cP to about 300 cP at a shear rate from 0 s⁻¹ to about 10 s⁻¹, and wherein the viscosity decreases when the shear rate increases;
wherein the non-biological simulant has a color that approximates the color of human or animal arterial or venous blood; and
wherein when the non-biological simulant liquid forms a dried residue, the dried residue has a low gloss appearance that approximates the appearance of dried human or animal arterial or venous blood.

18. The non-biological simulant liquid of claim 17, further comprising an odor agent, the odor agent comprising vinyl pentyl ketone.

19. A training system comprising:
a water-based non-biological blood simulant capable of forming a solid or semisolid residue representative of clotting blood; and
a simulant gauze including a clotting agent, the clotting agent comprising a superabsorbent material;
wherein contact between the simulant gauze and the non-biological blood simulant induces formation of the solid or semisolid residue.

20. (canceled)

21. The training system of claim 19, wherein the simulant gauze comprises a laminate, wherein a middle layer of the laminate comprises a superabsorbent material layer.

22-26. (canceled)
